(19) United States
(12) Patent Application Publication
(10) Pub. No.: US 2010/0120972 A1
(43) Pub. Date: May 13, 2010

(54) COMPOSITE COMPOSITIONS INCLUDING SEMI-AROMATIC POLYAMIDES AND CARBON FIBER, AND ARTICLES THEREOF

(75) Inventor: Shengmei Yuan, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/612,738

(22) Filed: Nov. 5, 2009

Related U.S. Application Data
(60) Provisional application No. 61/113,280, filed on Nov. 11, 2008.

(51) Int. Cl. C08L 27/18

(52) U.S. Cl. 524/546

(57) ABSTRACT

Disclosed is a thermoplastic composite composition including at least one semi-aromatic polyamide; a surface-treated carbon fiber having an aromatic sizing; optionally, from 0 to about 25 wt % PTFE; wherein the surface-treated carbon fiber has less than 1.0 wt % weight loss at 380° C., as measured by thermo-gravimetric analysis in air at 10° C./min.

### CROSS REFERENCE TO RELATED APPLICATIONS

This application claims the benefit of U.S. Provisional Application No. 61/113,280, filed Nov. 11, 2008, which is incorporated herein by reference in its entirety.

### FIELD OF INVENTION

This invention is directed to thermoplastic composite compositions comprising thermoplastic semi-aromatic polyamides, surface-treated carbon fiber having aromatic sizing, and optionally PTFE powder. The invention, also, includes articles made from the composite compositions.

### BACKGROUND OF INVENTION

Engineering thermoplastic plastics are widely used in automotive, electric/electronic, and industrial applications due to high strength, high stiffness, and high heat stability. A variety of chopped fibers are used as reinforcement in engineering plastics. Usually a flexible coating of a sizing composition is applied to the surface of fiber to improve the handle ability of the fiber, prevent damage during composite forming process, and improve bonding. For instance, carbon fibers with epoxy coating on the surface as sizing are routinely incorporated in epoxy matrix resin to produce a rigid composite after curing. Most epoxy composites are cured at temperatures below 232° C.

Developing thermoplastic resins for high temperature applications requires the use of thermoplastic resins, such as semi-aromatic polyamides, that have very high melting points; for instance, greater than 260° C., and frequently higher than 300° C. These materials require processing temperatures typically in the range of 280° C. to 370° C.

Under such high temperature, conventional epoxy sizing agent and other low temperature aliphatic sizing agents undergo severe thermal decomposition, which results in poor mechanical performance.

Needed are thermoplastic composite compositions having carbon fibers with a sizing agent, that are capable of withstanding high process temperatures without decomposition and loss of handle ability and bonding properties.

### SUMMARY OF INVENTION

One aspect of the invention is a composite composition comprising:

a) about 40 to about 90 wt % of a semi-aromatic polyamide;

b) about 10 to about 50 wt % of a surface-treated carbon fiber having an aromatic sizing;

c) 0 to about 25 wt % fluoropolymer powder.

wherein said surface-treated carbon fiber has less than 1.0 wt % weight loss at 380° C., as measured by thermo-gravimetric analysis in air at 10° C./min.

Another embodiment of the invention is an article of manufacture comprising the composite composition as disclosed above.

### DETAILED DESCRIPTION OF INVENTION

Thermoplastic semi-aromatic polyamides are particularly preferred for the composites described herein. As used herein, “semi-aromatic polyamide” means a polyamide containing both divalent aromatic groups and divalent non-aromatic groups. As used herein, “a divalent aromatic group” means an aromatic group with links to other parts of the polyamide molecule. For example, a divalent aromatic group may include a meta- or para-linked monocyclic aromatic group. Preferably the free valencies are to aromatic ring carbon atoms.

Semi-aromatic polyamides are well known in the art. The thermoplastic semi-aromatic polyamide may be one or more homopolymers, copolymers, terpolymers, or higher polymers that are derived in part from monomers that contain divalent aromatic groups. It may also be a blend of one or more aliphatic polyamides with one or more homopolymers, copolymers, terpolymers, or higher polymers that are derived in part from monomers containing divalent aromatic groups.

Preferred monomers containing divalent aromatic groups are terephthalic acid and its derivatives, isophthalic acid and its derivatives, and m-xylylenediamine. It is preferred that about 5 to about 75 mole percent of the monomers used to make the semi-aromatic polyamide used in the composites described herein contain divalent aromatic groups, and more preferred that about 10 to about 55 mole percent of the monomers contain divalent aromatic groups. Thus, preferably, about 5 to about 75 mole percent, or more preferably, 10 to about 55 mole percent of the repeat units of all polyamides used in the composites described herein contain divalent aromatic groups.

The semi-aromatic polyamide may optionally contain repeat units derived from one or more additional aliphatic dicarboxylic acid monomers or their derivatives, such as adipic acid, sebacic acid, azelaic acid, dodecanedioic acid, and other aliphatic or alicyclic dicarboxylic acid monomers having 6 to 20 carbon atoms. As used herein, “alicyclic” means a divalent non-aromatic hydrocarbon group containing a cyclic structure therein.

The semi-aromatic polyamide may optionally contain repeat units derived from one or more aliphatic or alicyclic diamine monomers having 4 to 20 carbon atoms. Preferred aliphatic diamines may be linear or branched and include hexamethylenediamine; 2-methyl-1,5-pentanediamine; 1,8-diaminooctane; 1,9-diaminononane; methyl-1,8-diaminooctane; 1,10-diaminodecane; and 1,12-diaminododecane. Examples of alicyclic diamines include 1-amino-3-aminomethyl-3,5,5,-trimethylcyclohexane; 1,4-bis(aminomethyl)cyclohexane; and bis(p-aminocyclohexyl)methane.

The semi-aromatic polyamide may optionally contain repeat units derived from lactams and aminocarboxylic acids (or acid derivatives), such as caprolactam, 11-aminoundecanoic acid, and laurylactam.

Examples of preferred semi-aromatic polyamides include poly(m-xylylene adipamide) (polyamide MXD,6); hexamethylene adipamide/hexamethylene terephthalamide copolyamide (polyamide 6,T/6,6); hexamethylene terephthalamide/2-methylpentamethylene terephthalamide copolyamide (polyamide 6,T/D,T); poly(dodecamethylene terephthalamide) (polyamide 12,T); poly(decamethylene terephthalamide) (polyamide 10,T); decamethylene terephthalamide/decamethylene dodecanoamide copolyamide (polyamide 10,T/10,12); poly(nonamethylene terephthalamide) (polyamide 9,T); the polyamide of hexamethylene isophthalamide and hexamethylene adipamide (polyamide 6,1/6,6); the polyamide of hexamethylene terephthalamide, hexamethylene isophthalamide, and hexamethylene adipamide (polyamide 6,T/6,I/6,6); and copolymers and mixtures of these polymers.

The semi-aromatic polyamide will preferably have a melting point that is at least about 280° C. and is preferably less than about 340° C.

The semi-aromatic polyamides useful in the invention have a glass transition equal to or greater than 80° C., preferably greater than 125° C.; and a melting point of equal to or greater than 260° C., and preferably greater than 290° C. The glass transition and melting points defined herein are determined using differential scanning calorimetry at a scan rate of 10° C./min. The glass transition is defined as the mid-point of the transition in the second heating cycle. The melting point is defined as the point of maximum endotherm in the melting transition in the second heating cycle.

Among the semi-aromatic polyamides, hexamethylene adipamide/hexamethylene terephthalamide copolyamide (polyamide 6,T/6,6) and hexamethylene terephthalamide/2-methylpentamethylene terephthalamide copolyamide (polyamide 6,T/D,T) are preferred.

In one embodiment the semi-aromatic polyamide is present in about 40 to about 90 wt %, preferably about 50 to 80 wt %, based on the total weight of the composite composition.

The surface-treated carbon fiber having an aromatic sizing, useful in the invention, has less than 1 wt % weight loss, more preferably less than 0.5 wt % weight loss, and more preferably less than 0.2 wt % weight loss at 380° C., as measured by thermo-gravimetric analysis (TGA) in air with a scan rate of 10° C./min.

FT-infrared analysis can be used to determine the type of sizing present on the carbon fiber. Aromatic sizing is characterized by strong sharp absorptions in the 1650 to 1450 cm⁻¹ range in the infrared.

One embodiment is wherein the aromatic sizing is selected from the group consisting of aromatic poly(amic acid) and aromatic polyimide. Such carbon fiber sizes are disclosed, for instance, in U.S. Pat. No. 4,394,467, hereby incorporated by reference. In one embodiment the size composition, which forms a size on the surface of the carbon fibers, comprises a polyamic acid. A poly(amic acid) herein refers to an oligomeric species having repeat units derived from the reaction of an aromatic dianhydride and an aromatic diamine and capable of providing a polyimide at elevated temperatures.

Aromatic dianhydride herein means a dianhydride wherein the dianhydride groups are bonded directly to an aromatic carbon atom. An aromatic diamine herein means a diamine wherein the amines are directly bonded to an aromatic carbon atom.

One embodiment is wherein the aromatic sizing comprises a polyamic acid wherein said polyamic acid is derived from the reaction of (1) at least one aromatic diamine, (2) at least one aromatic dianhydride, (3) and at least one aromatic tetracarboxylic acid diester in which each carboxylic acid group is positioned ortho to said carboxylic ester group.

Representative aromatic diamines are p-phenylenediamine, m-phenylenediamine, 4,4′-oxydianiline, 4,4′-methylenedianiline, 4,4′-diaminodiphenylsulfone, 4,4′-diaminobenzophenone, 4,4′-diaminobiphenyl, 3,3′-diaminodiphenylsulfone, 3,3′-diaminobenzophenone, and mixtures thereof. Particularly satisfactory results have been obtained when a mixture of approximately 95 percent by weight of p-phenylenediamine and approximately 5 percent by weight of m-phenylenediamine is selected. The aromatic diamine reactant is provided in a concentration of approximately 40 to 60 mole percent, preferably 45 to 55 mole percent, and more preferably about 50 mole percent based upon the total molar concentration of the aromatic diahydride, aromatic diamines and aromatic tetracarboxylic acid diester

Representative aromatic dianhydrides are 3,3′,4,4′-benzophenonetetracarboxylic dianhydride, pyromellitic dianhydride, 3,3′,4,4′-(hexafluoroisopropylidene)bis(phthalic anhydride), and mixture thereof.

Particularly satisfactory results have been obtained when 3,3′,4,4′-benzophenonetetracarboxylic dianhydride is selected. The aromatic dianhydride reactant is provided in a concentration of approximately 30 to 59 mole percent; preferably in a concentration of 30 to 49 mole percent; and more preferably about 35 mole percent based upon the total molar concentration of the aromatic diahydride, aromatic diamines and aromatic tetracarboxylic acid diester. The aromatic dianhydride is capable of undergoing reaction with the aromatic diamine at ambient conditions to yield a polyamic acid oligomer. The formation of polyamic acid oligomer may continue during the application of the size while the size composition is heated while present on the carbon fibers at moderate temperatures, e.g., at approximately 150° C.

The aromatic tetracarboxylic acid diester may be formed by known techniques through the reaction of an aromatic dianhydride with an alcohol having 1 to 6 carbon atoms. Representative alcohols for this reaction are methyl alcohol, ethyl alcohol, n-propyl alcohol, isopropyl alcohol, isobutyl alcohol, tert-butyl alcohol, n-amyl alcohol, hexyl alcohol, etc. The preferred alcohol for use when forming the aromatic tetracarboxylic acid diester is ethyl alcohol.

Representative aromatic tetracarboxylic acid diesters are 3,3′-diethylester of 3,3′,4,4′-benzophenonetetracarboxylic acid, 3,3′-diethylester of 3,3′,4,4′-(hexafluoroisopropylidene)bis(phthalic acid), 1,5-diethylester of pyromellitic acid, and mixtures thereof. Particularly satisfactory results have been obtained when the 3,3′-diethylester of 3,3′,4,4′-benzophenonetetracarboxylic acid is selected. The aromatic tetracarboxylic acid diester is provided in a concentration of approximately 1 to 20 mole percent and preferably 5 to 20 mole %, based upon the total molar concentration of the aromatic diahydride, aromatic diamines and aromatic tetracarboxylic acid diester, and most preferably in a concentration of about 15 mole percent based upon the total molar concentration of the aromatic diahydride, aromatic diamines and aromatic tetracarboxylic acid diester.

The aromatic size preferably is applied to the carbon fibers when dissolved in a polar solvent which is incapable of harming the carbon fibers. Representative solvents for the reactants and resulting polyamic acid are N-methyl pyrrolidone, dimethylformamide, dimethylacetamide, dimethylsulfoxide, etc.

The solution which is capable of forming the aromatic size coating may be applied to the carbon fibers by any suitable technique such as dipping, padding, etc. Once the solution is applied, the solvent is substantially volatilized by heating in an appropriate zone which is provided at a more highly elevated temperature.

Carbon fibers useful in the invention have a diameter of about 20 μm or less, more preferably about 10 μm or less. The carbon fiber may be made in a number of ways, for instance it may be “pitch based” or made from polyacrylonitrile. Preferably the carbon fiber has a tensile modulus of about 150 GPa or more.

One embodiment is a composite composition wherein the carbon fiber having an aromatic sizing is present at about 10 to 15 wt %, and preferably about 12.5 to about 15 wt %.

In one embodiment the carbon fiber having aromatic size is a chopped fiber strand or a continuous strand.

The composition of the invention, optionally, can include a fluoropolymer, which is used as a solid lubricant to enhance wear resistance in molded articles. In one embodiment the composition of the invention includes about 0.1 to 25 wt %, preferably 1 to 25 wt %, and more preferably 5 to 25 wt %, of fluoropolymer powder; based on the total weight of the composition. The composition of the fluropolymer can vary widely, so long as at least about 50%, and preferably at least about 75%, of the polymeric units are derived from tetrafluoroethylene. The balance of the polymeric units can be derived from any fluoroolefin which is copolymerizable with the tetrafluoroethylene, such as vinyl fluoride and hexafluoropropene.

Polytetrafluoroethylene homopolymer (PTFE) is particularly preferred on the basis of its low cost and ready availability. Of these, low molecular weight PTFE homopolymer, such as that commercially available from the Du Pont Company as Zonyl® MP-1400 fluoroadditive, is particularly effective at about 5 to 25 wt %, based on the total weight of the composite composition.

The composite composition can include other fillers, polymeric tougheners, flame retardants, heat stabilizers, viscosity modifiers, weatherability enhancers, and other additives known in the art, according to need. In one embodiment the composite composition, as disclosed above further comprises a component (d) consisting of about 15 to about 50 wt % of filler, other than carbon fiber. Fillers for component (d) are selected from the group consisting of glass fiber, including glass fiber having a non-circular cross-section, wollastonite, talc, mica, silica, calcium carbonate, glass beads, glass flake, and hollow glass spheres.

Glass fiber having a non-circular cross section refers to a glass fiber having a major axis lying perpendicular to a longitudinal direction of the fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape; a rectangular shape; an elliptical shape; a semielliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fiber having a non-circular cross section are disclosed in EP 0 190 001 and EP 0 196 194. The glass fiber may be in the form of long glass fibers, chopped strands, milled short glass fibers, or other suitable forms known to those skilled in the art.

Fillers for component (d) are preferably selected from the group consisting of glass fiber, glass fiber having a non-circular cross section, and a combination thereof.

In one embodiment the composite composition further comprises about 5 to 30 wt % glass fiber, glass fiber having a non-circular cross section, or a combination thereof; based on the total weight of the composite composition.

One embodiment of the invention is a composite composition further comprising about 5 to 15 wt % polymeric toughener. The “polymeric toughener” is meant a polymer, typically which is an elastomer or which has a relatively low melting point, generally <200° C., preferably <150° C., which preferably has attached to it functional groups which can react with the (usually end groups of) the polyamide. Since polyamides usually have carboxyl and amino (end) groups present, these functional groups usually can react with carboxyl and/or amino groups. Examples of such functional groups include epoxy, carboxylic anhydride, hydroxyl (alcohol), carboxyl, and isocyanato. Preferred functional groups are epoxy and carboxylic anhydride. Such functional groups are usually “attached” to the polymeric toughening agent by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl(meth)acrylate. In addition to ethylene and a difunctional (meth)acrylate monomer, other monomers may be copolymerized into such a polymer, such as vinyl acetate, unfunctionalized (meth)acrylate esters such as ethyl(meth)acrylate, n-butyl(meth)acrylate, and cyclohexyl(meth)acrylate. Preferred tougheners include those listed in U.S. Pat. No. 4,753,980, which is hereby included by reference. Especially preferred tougheners are copolymers of ethylene, ethyl acrylate or n-butyl acrylate, and glycidyl methacrylate, or elastomer such ethylene/propylene or ethylene/octene copolymers grafted with maleic anhydride.

The thermoplastic composition useful in the invention can be made by methods well known in the art for dispersing fillers and other additives with thermoplastic resins such as, for example, single screw extruder, a twin screw extruder, a roll, a Banbury mixer, a Brabender, a kneader or a high shear mixer.

The composition of the present invention may be formed into articles using methods known to those skilled in the art, such as, for example, injection molding. Such articles can include those for use in electrical and electronic applications, mechanical machine parts, and automotive applications. Articles for use in applications that require high stiffness and wear resistance are preferred. An embodiment of the invention is a molded article provided by the composite composition, and preferred embodiments, as disclosed.

The thermoplastic compositions of the invention are especially useful in conductive/static dissipation application, fuel application, and other industrial applications. For instance they can be used in applications such as hybrid electric motors, stators, connectors, coil formers, motor armature insulators, light housings, plugs, switches, switchgear, housings, relays, circuit breaker components, terminal strips, printed circuit boards, and housings for electronic equipment. (cross out those that do not apply; and add any you desire)

### Materials

Polymer A refers to a polyamide 6,T/D,6 copolymer having a melting point in the range of 305 to 315° C., available from E.I. du Pont de Neumours, Wilmington, Del.

Polymer B refers an ethylene/propylene/hexadiene terpolymer grafted with 1.8% maleic anhydride, was purchased from Dow Chemical (Midland, Mich., USA).

Polymer C refers to PTFE powder Zonyl® MP1400 available from E.I. du Pont de Neumours, Wilmington, Del.

Cu stabilizer refers to an inorganic copper salt thermal stabilizer.

Licowax® OP is a partially saponified ester wax manufactured by Clariant Corp., Charlotte, N.C. 28205, USA.

M 10-52 Talc is manufactured by Barretts Minerals, Inc., Dillon, Mont., USA.

CF1 refers to a chopped carbon fiber (nominally 0.8 cm length) having a sizing exhibiting a wt loss, as measured with TGA in air, of 2.23 wt % up to 380° C.

CF2 refers to chopped carbon fiber (nominal length about 3 to 6 mm) having an aromatic sizing exhibiting a wt loss, as measured with TGA in air, of 0.11 wt % up to 380° C.

Table 1 lists the % weight loss for CF1 and CF2, as determined with thermogravimetric analysis, in air and nitrogen atmospheres.

TABLE 1

| | CF1 | CF2 | CF1 | CF2 |
|---|---|---|---|---|
| Material | In Air | In Air | In N2 | In N2 |
| % weight | 0.98 | 0.08 | 0.28 | 0.00 |
| loss @ 300° C. | | | | |
| % weight | 1.60 | 0.11 | 0.62 | 0.00 |
| loss @ 350° C. | | | | |
| % weight | 2.23 | 0.11 | 1.26 | 0.00 |
| loss @ 380° C. | | | | |

### Compounding and Molding Methods

The compositions were made by mixing in a Werner & Pfleiderer 30 mm twin screw extruder at a nominal rate of about 13.6 kg/h at melt temperature between 340-360° C. All resin components and additives were fed from one feeder at the back of the extruder. The chopped fibers were fed from a side feeder in the middle of the extruder. The compounded pellets were molded into 4 mm multipurpose tensile bars on a Nissie FN3000 injection molding machine. Compositions and physical properties are given in Tables 1 and 2.

### Testing Methods

Weight loss was measured by thermogravimetric analysis (TGA) under air or nitrogen atmosphere as indicated in Table 1. TGA was conducted on an Auto TGA 2950 V5.4A instrument (TA Instruments). In each case, a 14-40 mg sample was positioned in aluminum pans. The weight loss was measured as follows: the temperature was increased at 10° C./min from 23° C. and the weight loss was measured in weight % relative to the initial weight.

Melt Viscosity was measured using Kayeness capillary Rheometer (Model LCR 5052m). Compounded Resin pellets were loaded into load cell maintained at 325° C. After preheating samples for 5 min, viscosity was measured and repeated every other 4-5 min subsequently to about total 30 min duration.

Tensile strength, elongation at break, and tensile modulus were tested on a tensile tester by ISO 527-1/-2 at 23° C. and stain rate of 5 mm/min at either room temperature on samples that were dry as molded or at designated temperatures.

Notched Izod was tested on a CEAST Impact Tester by ISO 180 at 23° C. on a Type 1A multipurpose specimen with the end tabs cut off. The resulting test sample measures 80×10×4 mm. (The depth under the notch of the specimen is 8 mm). Specimens were dry as molded.

Un-notched Izod was tested on a CEAST Impact Tester by ISO 180 at 23° C. on a Type 1A multipurpose specimen with the end tabs cut off. The resulting test sample measures 80×10×4 mm. Specimen were dry as molded.

Heat deflection temperature (HDT) was determined per ISO 75 at designated pressure of 1.80 MPa.

### Examples

Examples 1 and 2, listed in Table 3, illustrate the improvement in physical properties provided by compositions containing carbon fiber with aromatic sizing and having a very low weight loss at 380° C.; as compared to Comparative Examples C-1 and C-2, that include a carbon fiber have a 2.23 wt % loss up to 380° C., as measured by TGA in air.

Melt viscosities for Examples 1 and 2 and comparative examples 1 and 2 are listed in Table 2. The data indicate that Examples 1 and 2, unexpectedly, show that the viscosity of Examples 1 and 2 are significantly higher at 325° C.; and also show a significant retention of viscosity; as compared to the comparative examples 1 and 2. Comparative examples having a conventional carbon fiber show significant reductions in viscosity over 0.5 hours at 325° C.

TABLE 2
Melt viscosity as a function of time at 325° C.

Example

| | C-1 | 1 | C-2 | 2 |
|---|---|---|---|---|
| Time | Viscosity | Viscosity | Viscosity | Viscosity |
| (min) | (Pa-s) | (Pa-s) | (Pa-s) | (Pa-s) |
| 6 | 9.4 | 16.9 | 13.4 | 107.2 |
| 10.8 | 15.7 | 214.8 | 115.2 | 297.2 |
| 15.5 | 6.8 | 192.6 | 49 | 272.8 |
| 20.3 | 6.3 | 176.4 | 37.1 | 251.7 |
| 25 | 8 | 165.8 | 42.5 | 246 |
| 29.7 | 13.8 | 164.2 | 62.6 | 258.5 |

Examples 3-5, listed in Table 4, illustrate the improvement in physical properties provided by compositions containing carbon fiber with aromatic sizing and having a very low weight loss at 380° C., and optionally including PTFE powder; as compared to Comparative Examples C-3 thru C-5, that include a carbon fiber have a 0.11 wt % weight loss up to 380° C., as measured by TGA in air.

TABLE 3

| Example | | C-1 | 1 | C-2 | 2 |
|---|---|---|---|---|---|
| Composition | | | | | |
| Polymer A | | 69 | 69 | 54 | 54 |
| Polymer B | | | | 5 | 5 |
| M10-52 Talc | | 0.35 | 0.35 | 0.35 | 0.35 |
| Licowax OP | | 0.25 | 0.25 | 0.25 | 0.25 |
| Cu Stabilizer | | 0.4 | 0.4 | 0.4 | 0.4 |
| CF2 | | | 30 | | 40 |
| CF1 | | 30 | | 40 | |
| DAM^{a} Properties | | | | | |
| Tensile | | 188 | 272 | 187 | 228 |
| strength(Mpa) | | | | | |
| Elongation to break | | 0.92 | 1.39 | 0.9 | 0.98 |
| (%) | | | | | |
| Tensile Modulus | | 22.301 | 25.341 | 27.86 | 30.737 |
| (Gpa) | | | | | |
| Notched Izod (kJ/m2) | | 5.71 | 5.95 | 6.21 | 7.21 |
| Unnotched | | 22.9 | 38 | 24.2 | 52.8 |
| lzod(kJ/m2) | | | | | |
| Flexual Modulus | | 19.912 | 21.57 | 22.609 | 26.44 |
| (Gpa) | | | | | |
| AOA^{b} 180° C. | | | | | |
| Tensile | DAM | 188 | 272 | 187 | 228 |
| strength | 250 h | 175 | 234 | 124 | 181 |
| | 500 h | 101 | 239 | 101 | 186 |
| | 1000 h | 146 | 206 | 90 | 157 |
| Elongation @ | DAM | 0.92 | 1.39 | 0.9 | 0.98 |
| Break | 250 h | 0.88 | 1.1 | 0.51 | 0.71 |
| | 500 h | 0.4 | 1.1 | 0.4 | 0.71 |
| | 1000 h | 0.67 | 0.96 | 0.36 | 0.6 |

^{a}DAM = dry as molded;
^{b}AOA = air oven ageing.

TABLE 4

| Example | | 3 | C-3 | 4 | C-4 | 5 | C-5 |
|---|---|---|---|---|---|---|---|
| Composition | | | | | | | |
| Polymer A | | 54 | 54 | 59.35 | 55.61 | 44 | 44 |
| Polymer C | | 15 | 15 | | | 15 | 15 |
| M10-52 Talc | | 0.35 | 0.35 | 0.35 | 0.35 | 0.35 | 0.35 |
| Licowax OP | | 0.25 | 0.25 | 0.25 | 0.25 | 0.25 | 0.25 |
| Cu Stabilizer | | 0.4 | 0.4 | 0.4 | 0.75 | 0.4 | 0.4 |
| CF2 | | 30 | | 40 | | 40 | |
| CF1 | | | 30 | | 43.04 | | 40 |
| Properties | | | | | | | |
| Tensile. | 23° C. | 226 | 176 | 259 | 171 | 194 | 165 |
| Strength | 120° C. | 138 | 112 | 161 | 109 | 122 | 109 |
| (Mpa) | 150° C. | 74 | 59 | 79 | 50 | 66 | 52 |
| Tensile. | 23° C. | 24.9 | 20.5 | 30.7 | 31.8 | 31.3 | 26.5 |
| Modulus | 120° C. | 20.9 | 17.3 | 25.8 | 23.4 | 26 | 20.4 |
| (GPa) | 150° C. | 12.1 | 8.6 | 13.7 | 9.5 | 12.8 | 10.5 |

| | | | | | | |
|---|---|---|---|---|---|---|
| Notched Izod (kJ/m²) | 6.2 | 4.5 | 5.8 | 7. 1 | 6.5 | 4.9 |
| Unnotched Izod (kJ/m²) | 38.3 | 26.9 | 42.8 | 23.5 | 27.5 | 21.4 |
| HDT^{a} 1.8 MPa (° C.) | 267 | 256 | 265 | 237 | 266 | 254 |

^{a}HDT = heat distortion temperature.

What is claimed is:

1. A composite composition comprising:
a) about 40 to about 90 wt % of a semi-aromatic polyamide;
b) about 10 to about 50 wt % of a surface-treated carbon fiber having an aromatic sizing;
c) 0 to about 25 wt % fluoropolymer powder.
wherein said surface-treated carbon fiber has less than 1.0 wt % weight loss at 380° C., as measured by thermo-gravimetric analysis in air at 10° C./min.

2. The composition of claim 1 wherein the semi-aromatic polyamide is selected from the group consisting of: one or more homopolymers, copolymers, terpolymers, and higher polymers that are derived in part from monomers that contain divalent aromatic groups; and a blend of one or more aliphatic polyamides with one or more homopolymers, copolymers, terpolymers, or higher polymers that are derived in part from monomers containing divalent aromatic groups.

3. The composition of claim 1 wherein the semi-aromatic polyamide is selected from poly(m-xylylene adipamide); hexamethylene adipamide/hexamethylene terephthalamide copolyamide; hexamethylene terephthalamide/2-methylpentamethylene terephthalamide copolyamide; poly(dodecamethylene terephthalamide); poly(decamethylene terephthalamide); decamethylene terephthalamide/decamethylene dodecanoamide copolyamide; poly(nonamethylene terephthalamide); the polyamide of hexamethylene isophthalamide and hexamethylene adipamide; the polyamide of hexamethylene terephthalamide, hexamethylene isophthalamide, and hexamethylene adipamide; and a copolymer or mixture of these polymers.

4. The composition of claim 1 wherein the semi-aromatic polyamide is selected from hexamethylene terephthalamide/2-methylpentamethylene terephthalamide copolyamide and hexamethylene adipamide/hexamethylene terephthalamide copolyamide.

5. The composition of claim 1 wherein said aromatic sizing is selected from the group consisting of aromatic poly(amic acid) and aromatic polyimide.

6. The composition of claim 1 wherein the aromatic sizing comprises a polyamic acid wherein said polyamic acid is derived from the reaction of (1) at least one aromatic diamine, (2) at least one aromatic dianhydride, (3) and at least one aromatic tetracarboxylic acid diester in which each carboxylic acid group is positioned ortho to said carboxylic ester group.

7. The composition of claim 1 wherein the surface treated carbon fiber is a chopped fiber strand or a continuous strand.

8. The composition of claim 1 further comprising about 5 to 30 wt % glass fiber, glass fiber having a non-circular cross section, or a combination thereof, based on the total weight of the composite composition.

9. The composition of claim 1 further comprising about 5 to 15 wt % polymeric toughener.

10. The composition of claim 1 wherein the fluoropolymer powder is present at about 5 to 25 wt %, based on the total weight of the composite composition.

11. An injection-molded article made from the composite composition of claim 1.

12. An injection-molded article made from the composition of claim 8, 9, or 10.
